(19) United States
(12) Patent Application Publication
(10) Pub. No.: US 2016/0027204 A1
(43) Pub. Date: Jan. 28, 2016

(54) DATA PROCESSING METHOD AND DATA PROCESSING APPARATUS

(71) Applicant: SAMSUNG ELECTRONICS CO., LTD., Suwon-si (KR)

(72) Inventors: Wonjong Lee, Seoul (KR); Youngsam Shin, Hwaseong-si (KR); Jaedon Lee, Yongin-si (KR); Seokjoong Hwang, Seoul (KR)

(73) Assignee: SAMSUNG ELECTRONICS CO., LTD., Suwon-si (KR)

(21) Appl. No.: 14/665,120

(22) Filed: Mar. 23, 2015

(30) Foreign Application Priority Data
Jul. 22, 2014 (KR) 10-2014-0092657

(51) Int. Cl. G06T 15/06; G06T 15/50

(52) U.S. Cl. CPC G06T 15/06; G06T 15/50

(57) ABSTRACT

A data processing method and a data processing apparatus are provided. The data processing method includes storing ray data in an input buffer, requesting shape data that is used in ray tracing of the ray data, acquiring additional information corresponding to the shape data in response to the request and storing the additional information in a storage space allocated to the ray data, and determining an output order of pieces of ray data stored in the input buffer, based on the additional information.

### CROSS-REFERENCE TO RELATED APPLICATIONS

This application claims the benefit of Korean Patent Application No. 10-2014-0092657 filed on Jul. 22, 2014, in the Korean Intellectual Property Office, the disclosure of which is incorporated herein in its entirety by reference.

### BACKGROUND

1. Field

The following description relates to a method and apparatus for processing data when image rendering is performed.

2. Description of Related Art

In general, 3-dimensional (3D) rendering refers to image processing in which 3D object data is synthesized into a graphical image of the object that is shown at a given camera viewpoint.

Examples of a rendering method include a rasterization method that generates an image by projecting a 3D object onto a 2D screen, and a ray tracing method that generates an image by tracing the path of light that is incident along a ray traveling toward each image pixel at a camera viewpoint.

The ray tracing method may generate a high-quality image because it takes into account the physical properties, such as reflection, refraction, transmission, and so on, of light in a rendering result. However, the ray tracing method has difficulty for use in high-speed rendering, such as real-time rendering, because it requires a relatively large number of calculations.

With respect to ray tracing performance, factors leading to a large number of calculations include generation and traversal (TRV) of an acceleration structure (AS) in which scene objects to be rendered are spatially separated, and an intersection test (IST) between a ray and a primitive.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Provided are methods and apparatuses for preventing occurrence of a stall in program execution even when a cache miss occurs.

Additional aspects of the present application are set forth in the description which follows and are apparent from the description, or are learned by practice of the examples.

In one general aspect, a data processing method includes storing ray data in an input buffer, requesting shape data that is used in ray tracing of the ray data, acquiring additional information corresponding to the shape data in response to the request and storing the additional information in a storage space allocated to the ray data, and determining an output order of pieces of ray data stored in the input buffer, based on the additional information.

The requesting of the shape data may include requesting of a cache to transmit the shape data, and the determining of the output order may include determining that the ray data is to be output first, when the shape data corresponding to the ray data is contained in the cache.

The data processing method may further include outputting the ray data and deleting the ray data from the input buffer, in response to the shape data being contained in the cache.

The requesting of the shape data may include requesting of a cache to transmit the shape data, and the additional information may include at least one of a point in time at which the shape data was requested, cache miss information indicating whether the shape data is contained in the cache, a point in time at which the cache miss information was received, and a memory address where the shape data is stored.

The determining of the output order may include setting pieces of ray data that have an identical memory address to be output in the same order as each other or in an adjacent order to each other.

The determining of the output order may include, in response to the shape data not being contained in the cache, setting ray data that has a larger time difference between the point in time when the cache miss information has been received and a current point in time, to be output earlier than ray data that has a smaller time difference therebetween.

The determining of the output order may include, in response to the shape data not being contained in the cache, determining the output order based on a result of a comparison between a latency time difference between the point in time at which the cache miss information has been received and a current point in time and an estimated time difference that is a time interval taken to transmit data from a memory to the cache.

The shape data may include at least one of node data that is used in a traversal (TRV) of an acceleration structure (AS) during ray tracing and primitive data that is used in an intersection test (IST) during ray tracing.

The data processing method may include outputting the ray data and the shape data to a traversal (TRV) unit or an intersection test (IST) unit in the determined output order.

In another general aspect, a data processing apparatus includes a controller configured to request shape data that is used in ray tracing of ray data and determines an output order of pieces of ray data stored in an input buffer, based on additional information about the shape data, and an input buffer configured to store additional information acquired in response to the request of the controller for the shape data in a storage space allocated to each of the pieces of ray data.

The controller may request of a cache to transmit the shape data and, in response to the shape data being contained in the cache, determines that the ray data is to be output first.

The controller may output the ray data and may delete the ray data from the input buffer, in response to the shape data being contained in the cache.

The controller may request of a cache to transmit the shape data, and the additional information may include at least one of a point in time when the shape data has been requested, cache miss information indicating whether the shape data is contained in the cache, a point in time at which the cache miss information has been received, and a memory address where the shape data is stored.

The controller may set pieces of ray data that have an identical memory address to be output in the same order as each other or in an adjacent order to each other.

The controller may set ray data that has a larger time difference between the point in time when the cache miss information has been received and a current point in time, to be output earlier than ray data which has a smaller time difference therebetween, in response to the shape data not being contained in the cache.

In response to the shape data not being contained in the cache, the controller may determine the output order based on a result of a comparison between a latency time difference between the point in time at which the cache miss information has been received and a current point in time and an estimated time difference that is a time interval taken to transmit data from a memory to the cache.

The shape data may include at least one of node data that is used in a traversal (TRV) of an acceleration structure (AS) during ray tracing and primitive data that is used in an intersection test (IST) during ray tracing.

The controller may output the ray data and the shape data to a traversal (TRV) unit or an intersection test (IST) unit in the determined output order.

In another general aspect, a non-transitory computer-readable recording medium stores a program for data processing, the program including instructions for causing a computer to perform the data processing method discussed above.

In another general aspect, a data processing method includes requesting shape data that is used in ray tracing of ray data stored in an input buffer, acquiring additional information corresponding to the shape data in response to the request and storing the additional information in a storage space allocated to the ray data, and determining an output order of pieces of ray data stored in the input buffer, based on the additional information.

Other features and aspects will be apparent from the following detailed description, the drawings, and the claims.

### BRIEF DESCRIPTION OF THE DRAWINGS

FIG. 1 is a diagram illustrating a general ray tracing method.

FIG. 2 is a schematic block diagram of a data processing apparatus, according to various examples.

FIG. 3 is a block diagram illustrating a method in which the data processing apparatus is implemented in a ray tracing apparatus, according to various examples.

FIG. 4 is a flowchart of a method for determining an output order of pieces of ray data, according to various examples.

FIG. 5 is a block diagram for explaining a method of storing additional information corresponding to each ray data in a storage space allocated to the ray data, according to various examples.

FIG. 6 is a flowchart of the method of FIG. 5.

FIG. 7 is a block diagram illustrating a method of adding additional information to an input buffer, according to various examples.

FIG. 8 is a flowchart of the method of FIG. 7.

FIG. 9 is a block diagram illustrating a method of processing cache-missed ray data, according to various examples.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Reference will now be made in detail to examples, which are illustrated in the accompanying drawings, wherein like reference numerals refer to the like elements throughout. In this regard, the present examples may have different forms and should not be construed as being limited to the descriptions set forth herein. Accordingly, the examples are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

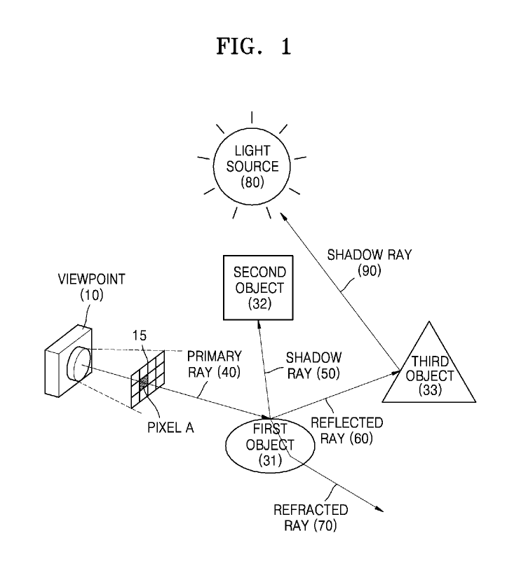

A data processing method and a data processing apparatus according to various examples is now described with reference to FIGS. 1-9.

Herein, an expression used in the singular encompasses the expression with respect to the plural, unless it has a clearly different meaning in the context of the expression.

Examples are described more fully hereinafter with reference to the accompanying drawings. In the drawings, like elements are denoted by like reference numerals, and a repeated explanation of the examples is not given.

FIG. 1 is a diagram illustrating a general ray tracing method.

As illustrated in the example of FIG. 1, 3-dimensional (3D) modeling includes a light source 80, a first object 31, a second object 32, and a third object 33. In FIG. 1, the first object 31, the second object 32, and the third object 33 are represented as 2-dimensional (2D) objects. However, this is merely for convenience of description, and the first object 31, the second object 32, and the third object 33 in some examples are 3D objects themselves.

In this example, it is assumed that the reflectivity and refractivity of the first object 31 are greater than 0, and the reflectivity and refractivity of the second object 32 and the third object 33 are 0. In other words, it is assumed that the first object 31 reflects and refracts light, and the second object 32 and the third object 33 neither reflects nor refracts light.

In the 3D modeling approach illustrated in FIG. 1, a rendering apparatus, for example, a ray tracing unit, determines a viewpoint 10 to generate a 3D image and determine a screen 15 corresponding to the determined viewpoint 10.

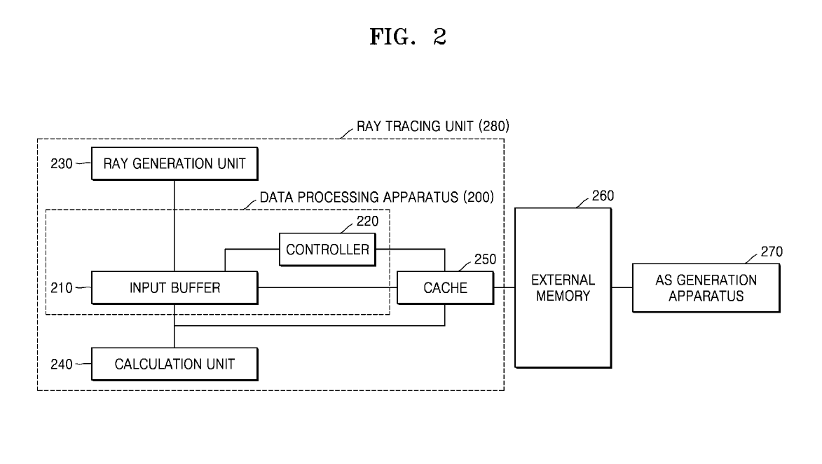

When the viewpoint 10 and the screen 15 are determined, in this example, a ray tracing unit 280, discussed further in FIG. 2, generates a ray for each pixel of the screen 15 from the viewpoint 10.

For example, as illustrated in FIG. 1, when the screen 15 has a resolution of about 4×3 pixels, the ray tracing unit 280 generates a ray for each of the 12 pixels of the screen 15.

In the following discussion, only a ray for one example pixel, pixel A, is described.

Referring to FIG. 1, a primary ray 40 is generated for the pixel A from the viewpoint 10. The primary ray 40 passes through a 3D space from the viewpoint 10 through the screen 15 and subsequently reaches the first object 31. In this example, the first object 31 includes a set of unit regions, hereinafter, referred to as primitives. The primitives have, for example, the shape of a polygon such as a triangle or a quadrangle. In the following example, the primitive has the shape of a triangle.

A shadow ray 50, a reflected ray 60, and a refracted ray 70 are potentially generated at a hit point between the primary ray 40 and the first object 31, at which the primary ray 40 intersects with the exterior of the first object 31. In this example, the shadow ray 50, the reflected ray 60, and the refracted ray 70 are referred to as secondary rays because they are rays that are side-effects resulting from the interaction of primary ray 40 with the first object 31.

The shadow ray 50 is generated from the hit point toward the light source 80. The reflected ray 60 is generated in a direction corresponding to an incidence angle of the primary ray 40, and is given a weight corresponding to the reflectivity of the first object 31. The refracted ray 70 is generated in a direction corresponding to the incidence angle of the primary ray 40 and the refractivity of the first object 31, and is given a weight corresponding to the refractivity of the first object 31. Thus, these secondary rays incorporate into the rendering process the aspects of the first object 31 that the first object 31 has a shadow, reflective properties, and refractive properties.

The ray tracing unit 280 determines whether the hit point is exposed to the light source 80, through analyzing the shadow ray 50. For example, as illustrated in FIG. 1, when the shadow ray 50 meets the second object 32, a shadow may be generated at the hit point where the shadow ray 50 is generated, because light traveling along the path of the shadow ray 50 will intersect the second object 32, and hence the second object 32 will cast a shadow on the first object and this information is to be taken into account when performing the rendering.

The ray tracing unit 280 also determines whether the refracted ray 70 and the reflected ray 60 reach other objects. This information determines how to take into account the effects of the refracted ray 70 and the reflected ray 60 when performing the ray tracing. For example, as illustrated in FIG. 1, no objects exist in a traveling direction of the refracted ray 70. However, the reflected ray 60 reaches the third object 33. Accordingly, the ray tracing unit 280 detects coordinate and color information of a hit point between the reflected ray 60 and the third object 33 and generates a corresponding shadow ray 90 from the hit point between the reflected ray 160 and the third object 33. In this case, the ray tracing unit 280 determines whether the shadow ray 90 is exposed to the light source 80. In this example, the shadow ray 90 is exposed to the light source 80.

Since the reflectivity and refractivity of the third object 33 are 0, neither a reflected ray nor a refracted ray is generated from the third object 33.

As described above, the ray tracing unit 280 analyzes the primary ray 40 for the pixel A and all rays derived from the primary ray 40 and determines a color value of the pixel A based on a result of the analysis, which incorporates all of the ray information resulting from the prior analysis. The determination of the color value of the pixel A, in this example, depends on the color of a hit point of the primary ray 40, the color of a hit point of the reflected ray 60, and whether the shadow ray 50 reaches the light source 80.

The ray tracing unit 280 may construct the screen 15 by performing the above-described process of considering the path of primary light rays and their intersection with objects as well as including effects of secondary rays resulting from shadows, reflection, and refraction, on all of the pixels of the screen 15.

FIG. 2 is a schematic block diagram of a data processing apparatus 200 according to various examples.

Referring to the example of FIG. 2, the ray tracing unit 280 includes a ray generation unit 230, the data processing apparatus 200, a calculation unit 240, and a cache 250. In this example, the data processing apparatus 200 includes an input buffer 210 and a controller 220.

Although the input buffer 210 and the controller 220 are included in the data processing apparatus 200 in the example of FIG. 2, the input buffer 210 and the controller 220 are implemented using separate hardware in other examples.

Only components related to the present example from among the components of the data processing apparatus 200 are shown in FIG. 2. It is to be understood by one of ordinary skill in the art with respect to the present example that general-use components other than the components illustrated in FIG. 2 may be further included. Also, appropriate components may be used to substitute for the components illustrated in FIG. 2, in some examples.

The ray tracing unit 280 traces hit points between generated rays and objects positioned in a 3D space, and determines color values of the pixels that constitute a corresponding image on a screen. In other words, the ray tracing unit 280 searches for the hit points between rays and objects, generates secondary rays according to the characteristics of the objects at the hit points, and determines the relevant color values of the hit points that form a corresponding rendered image.

In the example of FIG. 2, when performing a traversal (TRV) and an intersection test (IST) on an acceleration structure (AS), the ray tracing unit 280 uses a result of a previous TRV and a result of a previous IST. In other words, the ray tracing unit 280 performs a current rendering more quickly by applying a result of a previous rendering to the current rendering. Hence, this approach improves performance by avoiding redundant processing.

The ray generation unit 230 generates a primary ray and a secondary ray. The ray generation unit 230 generates the primary ray from a viewpoint. The ray generation unit 230 generates the secondary ray at a hit point between the first ray and an object. In an example, the ray generation unit 230 also generates another secondary ray at a subsequent hit point between the secondary ray and another object. In other words, in such an example, the ray generation unit 230 generates a reflected ray, a refracted ray, or a shadow ray, at the hit point between the secondary ray and the object. Thus, secondary rays are not limited to considering only one reflection, refraction, or shadow effect, and some examples consider a plurality of such effects. In various examples, the ray generation unit 230 generates the reflected ray, the refracted ray, or the shadow ray within a predetermined number of times, or determines the number of times of generation of the reflected ray, the refracted ray, or the shadow ray according to the characteristics of the object. Hence, it is possible to control the number of secondary ray effects to provide a balance between the increased accuracy provided by considering multiple secondary ray effects and the additional processing required to consider large numbers of secondary ray effects.

In the example of FIG. 2, the input buffer 210 receives and stores ray data from the ray generation unit 230.

Also in FIG. 2, the controller 220 requests shape data that is used in ray tracing based on the received ray data. Shape data is used in ray tracing and shape data may include node data that is used in a TRV of an AS during ray tracing and object data that is used in an IST between a ray and a primitive during a ray tracing process.

In various examples, ray data includes information such as at least one selected from the type of ray, such as a primary ray, a shadow ray, or the like. In other examples, the ray data also including information such as the start point of the ray, the direction vector of the ray, the inverse direction vector of the ray, hit point information, such as occurrence or non-occurrence of a hit and the index of a hit primitive, a stack pointer, and the position of a pixel during shading. A stack pointer, according to an example, denotes the address of a storage space of a memory that retains items of the latest data stored in the memory.

Shape data, according to an example, refers to data that is used in ray tracing. In an example, the shape data is node data that is used in TRV. As another example, the shape data is primitive data that is used in an IST.

The cache 250 is a temporary memory that is incorporated within the ray tracing unit 280 to increase a data processing speed. A case where requested data is contained in the cache 250 is referred to a cache hit, and a case where requested data is not contained in the cache 250 is referred to a cache miss. If a cache miss occurs since requested data is not contained in the cache 250, the cache 250 fetches the requested data from the external memory 260.

Fetching, according to an example, refers to reading data from a memory. For example, fetching refers to a process in which a central processing unit acquires data in order to execute a command stored in a memory.

However, latency that occurs while an access to the external memory 260 located outside the ray tracing unit 280 occurs, in response to a cache miss having occurred potentially causes a processing speed of the entire data to be decrease.

When a calculation process for ray tracing in the calculation unit 240 is pipelined for improved processing performance, latency occurring during an access to the external memory 260 due to a cache miss also potentially causes a pipeline stall, further hindering performance.

To avoid a reduction in a calculation speed that could occur from issues such as the ones discussed above, in various examples the cache 250 is designed to have a non-blocking structure. For example, the cache 250 is designed to have a structure that is capable of responding to a data request that continues to perform successfully even after a cache miss occurs. Accordingly, when a cache miss has occurred with respect to first shape data corresponding to first ray data, the data processing apparatus 200 receives and then processes second ray data while the first shape data is still being fetched from the external memory 260. Thus, latency caused due to an access to the external memory 260 decreased by using in this approach. The latency decrease occurs because it is possible to continue a portion of the processing tasks while another portion requires information that requires a slow access to the external memory 260. For example, when a cache miss has occurred with respect to the first shape data, the controller 220 requests that the cache 250 provide the second shape data without waiting until the first shape data is transmitted from the external memory 260 to the cache 250, thereby managing and compensating for the latency caused by an access to the external memory 260.

In an example, the data processing apparatus 200 does not require a separate buffer to store cache-missed ray data. Thus, in such an example, the data processing apparatus 200 stores the cache-missed ray data in the input buffer 210 and does not output the cache-missed ray data to the calculation unit 240. Accordingly, the calculation unit 240 does not bypass the cache-missed ray data, and thus power consumption is advantageously reduced. The bypassing denotes a processing approach in which a pipeline passes over ray data without performing a substantial and/or resource-intensive calculation in order to avoid the occurrence of a pipeline stall.

Since the data processing apparatus 200 uses only the input buffer 210 and the cache 250 as data storage spaces, the data processing apparatus 200 is able to output ray data to the calculation unit 240 without including an additional memory.

For example, the input buffer 210 includes a storage space allocated to each ray data that is stored. In such an example, additional information corresponding to each ray data is stored in each allocated storage space. For example, if the input buffer 210 is able to store 100 pieces of ray data, additional information corresponding to each of the 100 pieces of ray data is additionally stored in a storage space allocated for each of the 100 pieces of ray data.

The controller 220 requests that the cache 250 provides shape data corresponding to the ray data received by the input buffer 210 from the ray generation unit 230. In an example, the input buffer 210 stores additional information acquired by request in a storage space allocated for the received ray data.

The controller 220 determines an output order of the pieces of ray data, based on pieces of additional information respectively corresponding to the pieces of ray data stored in the input buffer 210.

The controller 220 dynamically reorders the pieces of ray data stored in the input buffer 210. For example, the controller 220 determines the output order of the pieces of ray data stored in the input buffer 210, by using the pieces of additional information respectively corresponding to the pieces of ray data stored together with the pieces of ray data in the input buffer 210. In an example, the controller 220 performs the reordering without using additional memory.

In an example, the additional information is information about the shape data. For example, in various examples, the additional information includes at least one type of additional incorporation selected from a point in time when the controller 220 has requested that the cache 250 provide shape data, cache miss information indicating whether the requested shape data is contained in the cache 250, a point in time when the controller 220 has received the cache miss information, and a memory address representing the address of the external memory 260 where the shape data is stored. However, these are only examples of additional information, and additional information includes other types of relevant information about the shape data in examples.

As another example, when the controller 220 has requested for the cache 250 to provide the shape data, a point in time when the request was made by the controller 220 or a point in time when information about the request has reached the cache 250 are included in the additional information in such an example.

As another example, when the controller 220 has requested for the cache 250 to provide the shape data, cache miss information indicating whether the requested shape data is contained in the cache 250 is included in the additional information. Information indicating whether requested shape data is contained in the cache 250 when the controller 220 has requested the cache 250 for the shape data is referred to as cache miss information.

When requested shape data is not found in the cache 250 even though the requested shape data is contained in the cache 250, the controller 220 determines that the requested shape data is not contained in the cache 250. For example, when requested shape data is not found in the cache 250 due to an error or similar retrieval problem even though the requested shape data is actually contained in the cache 250, the controller 220 may receive cache miss information indicating that the requested shape data is not contained in the cache 250.

Information indicating whether requested shape data is contained in the cache 250 when the controller 220 has requested that the cache 250 provided the shape data may be 1-bit data, indicating a yes/no or true/false Boolean information with respect to whether or not the requested shape data is contained in the cache. Bit data representing a cache miss is referred to as a valid bit. For example, cache miss information is expressed with a valid bit, where the bit's value indicates whether a cache miss has occurred.

A valid bit, according to an example, is initially set to be 1. When it is determined that requested shape data is not contained in the cache 250, and thus a cache miss has occurred, the valid bit is updated to 0. Accordingly, when it is determined that the requested shape data is contained in the cache 250 and hence a cache hit has occurred, the value of the valid bit is maintained as the initially-set value without being updated.

As another example, a point in time at which the controller 220 has received cache miss information, or a point in time at which the cache miss information has been sent by the cache 250 is included in the additional information in such an example.

Additional information, according to an example, includes a time difference between the point in time at which the controller 220 has received cache miss information and a current point in time.

In an example, the additional information includes latency information that is a latency time difference between a point in time at which the controller 220 has received information indicating that shape data corresponding to each ray data stored in the input buffer 210 is not contained in the cache 250 with respect to a current point in time.

In another example, the additional information includes an estimated time difference that is a time interval expected to be taken in order to transmit data from the external memory 260 to the cache 250.

Additional information according to an example includes information about a cache miss cycle representing a cycle of the point in time when the information indicating that the shape data corresponding to each ray data stored in the input buffer 210 is not contained in the cache 250 has been received. The cycle denotes the cycle of an operation that repeats regularly when the data processing apparatus 200 operates at regular intervals.

Additional information according to another example includes a current cycle.

Additional information according to another example includes a latency cycle corresponding to a value obtained by subtracting the cache miss cycle from the current cycle.

Additional information according to another example includes an estimated cycle that is a cycle expected to be taken in order to transmit data from the external memory 260 to the cache 250.

Additional information according to another example includes a latency counter.

A latency counter according to an example refers to a value obtained by subtracting the current cycle from a sum of the estimated cycle and the cache miss cycle. For example, 150 cycles are used to transmit data from the external memory 260 to the cache 250. When a cycle at a point in time at which a cache miss has occurred is the 200^{th} cycle and a cycle at a current point in time is the 300^{th} cycle, the latency counter is 50, in keeping with the approach discussed above. The latency counter according to such an example is to be set to be no less than 0. Accordingly, when the number of cycles taken until the current point in time after the point in time when a cache miss has occurred is greater than the estimated number of cycles, the latency counter is set to 0, rather than taking on a negative value.

The controller 220 determines the output order of the pieces of ray data stored in the input buffer 210, by using the latency counter. For example, a method in which the controller 220 determines the output order of the pieces of ray data stored in the input buffer 210 by using a latency counter is described further, below.

The controller 220 assigns an output order to each of the pieces of ray data stored in the input buffer 210. A method in which the controller 220 assigns an output order to each of the pieces of ray data stored in the input buffer 210 is now be described in detail. In particular, as described above, the controller 220 determines the order in which the pieces of ray data stored in the input buffer 210 are output, based on individual pieces of the pieces of additional information that respectively correspond to the stored pieces of ray data.

The controller 220 determines a latency time difference for each of the pieces of ray data stored in the input buffer 210. For example, the controller 220 sets ray data having a larger latency time difference as being output earlier than ray data having a smaller latency time difference.

For example, the latency time difference refers to a period of time that has lapsed after the controller 220 has requested for the cache 250 to provide the shape data. In such an example, the latency time difference of ray data refers to a time difference between a point in time at which the controller 220 has requested for the cache 250 to provide shape data corresponding to the ray data and a current point in time.

By setting ray data that has a larger latency time difference to be output earlier than ray data that has a smaller latency time difference, the probability of a cache hit increases, because organizing the ray data in this manner improves cache performance, as is discussed further.

An example in which the probability of a cache hit is increased by setting ray data that has a larger latency time difference to be output earlier than ray data that has a smaller latency time difference is now further illustrated and explained. A point in time at which the controller 220 has requested the cache 250 for first shape data corresponding to ray data that has a larger latency time difference is, in this example, earlier than a point in time when the controller 220 requested the cache 250 for second shape data corresponding to ray data that has a smaller latency time difference. Since the request for the first shape data was made earlier than the request for the second shape data, the probability that the first shape data exists in the cache 250 is therefore higher than the probability that the second shape data exists in the cache 250. Accordingly, a cache hit probability is likely to be higher when the cache 250 is requested to provide the first shape data rather than when the cache 250 is requested to provide the second shape data. Therefore, the controller 220 increases the probability of a cache hit by setting ray data that has a larger latency time difference to be output earlier than ray data that has a smaller latency time difference.

The controller 220 determines the latency time difference and the estimated time difference. The controller 220 determines the output order of each ray data stored in the input buffer 210, based on a result of a comparison between the latency time difference and the estimated time difference.

For example, the controller 220 includes, in an output target, only pieces of ray data that have respective latency time differences that are larger than respective estimated time differences, where the pieces of ray data are chosen from among the pieces of ray data stored in the input buffer 210. The controller 220 determines an output order for only the pieces of ray data included in the output target and potentially does not determine an output order for pieces of ray data which are not included in the output target.

In such an example, the controller 220 determines the output order for the pieces of ray data included in the output target, by using the additional information as discussed above. For example, the controller 220 determines the output order for the pieces of ray data included in the output target such that an output order increases as a value obtained by extracting an estimated time difference from a latency time difference increases.

When the latency time difference of data is larger than the estimated time difference thereof, a period of time that lapsed after the external memory 260 was requested for the data is potentially longer than a period of time that is taken to transmit the data from the external memory 260 to the cache 250.

As another example, the controller 220 sets pieces of ray data that have respective latency time differences that are larger than respective estimated time differences from among the pieces of ray data stored in the input buffer 210, to be output earlier than new ray data.

As another example, when determining the output order of the pieces of ray data stored in the input buffer 210, the controller 220 sets ray data, which has a larger value resulting from the subtraction “latency time difference—estimated time difference”, so as to be output earlier than ray data that has a smaller value resulting from the subtraction “latency time difference—estimated time difference.”

The controller 220 considers a valid bit when determining the output order of the pieces of ray data stored in the input buffer 210.

When it is determined that requested shape data is not contained in the cache 250, and hence a cache miss occurs, a valid bit according to an example is set to be 0. When it is determined that the requested shape data is contained in the cache 250 and hence a cache hit has occurred, the valid bit is set to be 1.

In this case, the controller 220 determines that ray data having a valid bit of 1 from among the pieces of ray data stored in the input buffer 210 is to be output first.

As another example, the controller 220 includes only pieces of ray data having a valid bit of 1 from among the pieces of ray data stored in the input buffer 210, in an output target. In this example, the controller 220 determines an output order for only the pieces of ray data included in the output target and does not determine an output order for pieces of ray data not included in the output target.

When determining the output order of the pieces of ray data stored in the input buffer 210, in various examples the controller 220 assigns the same output order or adjacent output orders to pieces of ray data that have the same memory addresses, based on the pieces of additional information corresponding to the stored pieces of ray data.

For example, when a first memory address has been accessed, all of a plurality of pieces of ray data stored in the first memory address are accessible. Accordingly, when a cache hit has occurred for one of the pieces of ray data that correspond to an identical memory address, a cache hit also potentially occurs for the other pieces of ray data. Thus, the controller 220 assigns an identical output order or adjacent output orders to the pieces of ray data corresponding to the identical memory address, thereby increasing a similarity between the output orders of the pieces of ray data that correspond to the identical memory address.

For example, the controller 220 sets first ray data and second ray data, respectively corresponding to first shape data and second shape data that are stored in an identical memory address, so as to be output in the same order. One piece of ray data that is selected randomly from among the pieces of ray data that have the same output orders is output to the calculation unit 240, earlier than the other pieces of ray data.

As another example, the controller 220 sets first ray data and second ray data that respectively correspond to first shape data and second shape data that are stored in an identical memory address so as to be output in an adjacent order to each other. Thus, in such an example, when the output order of the first ray data having a larger latency time difference from among the first ray data and the second ray data is the 7^{th} order, the output order of the second ray data is the 8^{th} order.

Thus, in this example, when the controller 220 has requested the cache 250 for shape data and the requested shape data is contained in the cache 250, the controller 220 then determines that the requested shape data is to be output first.

Accordingly, when the requested shape data is contained in the cache 250, the input buffer 210 receives the requested shape data from the cache 250 and outputs the received shape data and ray data corresponding to the received shape data earlier than the other pieces of ray data. As described above, the output ray data is deleted from the input buffer 210 after being output.

The latency counter is used when the controller 220 determines the output order of pieces of cache-missed ray data and new ray data.

For example, the controller 220 sets the output order of new ray data to be higher than that of ray data having a latency counter value of 0 or greater.

The controller 220 outputs the pieces of ray data stored in the input buffer 210 and the pieces of shape data that respectively correspond to the stored pieces of ray data, in the determined output order. For example, the controller 220 outputs received shape data and ray data corresponding to the received shape data to the calculation unit 240. In an example, the shape data is output from the cache 250 directly to the calculation unit 240. In such an example, the controller 220 outputs both ray data included in the output target and shape data corresponding to the ray data to the calculation unit 240.

Before outputting the ray data and the shape data, the controller 220 requests the cache 250 for the shape data. When requested shape data exists in the cache 250, the controller 250 outputs both ray data included in the output target and the shape data to the calculation unit 240.

In various examples, the calculation unit 240 includes an IST unit and a TRV unit as described later, and is pipelined.

Additionally, in some examples, the controller 220 deletes the output ray data and the output shape data.

In some examples, the input buffer 210 contains pieces of ray data corresponding to pieces of shape data that are determined to be not contained in the cache 250.

In an example, the input buffer 210 receives ray data from the ray generation unit 230 and stores the received ray data. In such an example, the controller 220 requests the cache 250 for shape data corresponding to the received ray data and performs different operations according to whether the requested shape data is contained in the cache 250.

For example, when the shape data which the controller 220 has requested from the cache 250 is contained in the cache 250, the controller 220 outputs the requested shape data and the ray data corresponding to the requested shape data to the calculation unit 240 and subsequently deletes such information.

As another example, when the shape data which the controller 220 has requested from the cache 250 is not contained in the cache 250, the input buffer 210 maintains the storage of the ray data that corresponds to the requested shape data.

The calculation unit 240 is a superordinate unit including both a TRV unit and an IST unit as subunits that are components of the calculation unit 240. For example, the calculation unit 240 receives ray data and node data that correspond to the ray data and performs TRV. As another example, the calculation unit 240 receives ray data and primitive data that correspond to the ray data and performs an IST.

With respect to rendering based on ray tracing, the calculation unit 240 performs a TRV of an AS in which scene objects to be rendered are spatially separated, and perform an IST between a ray and a primitive.

While the calculation unit 240 is performing a calculation such as a TRV or an IST, the cache 250 in an example fetches at least some of pieces of shape data corresponding to pieces of ray data stored in the external memory 260 in advance, thereby increasing the speed of the calculation.

Executions of a TRV and an IST are now described further.

A TRV unit receives information about a ray generated by the ray generation unit 230 from the data processing apparatus 200. The ray includes a primary ray, a secondary ray, and all of the rays derived from the secondary ray. For example, the TRV unit receives information about the viewpoint and direction of the primary ray. The TRV unit also receives information about a start point and direction of the secondary ray. The start point of the secondary ray denotes a point of a primitive hit by the primary ray, as this is where the primary ray becomes the origin of a secondary ray. In this example, the viewpoint or the start point is represented by coordinates, and the direction is represented by a vector.

For example, the TRV unit reads information about an AS from the external memory 260. The AC is generated by the AS generation apparatus 270, and the generated AS is stored in the external memory 260. The AS is a structure that includes location information of objects in a 3D space. For example, the AS is generated by using a K-dimensional tree (KD-tree) and/or a bounding volume hierarchy (BVH).

The TRV unit searches for an AS and outputs an object or leaf node hit by a ray. Thus, the TRV unit searches for nodes included in the AS and outputs a leaf node hit by a ray from among the considered leaf nodes, which are the lowest nodes among the nodes, to the IST unit. In other words, the TRV unit determines which of the bounding boxes that constitute the AS has been hit by a ray. The TRV unit then determines which of the objects included in the hit bounding box have been hit by the ray. The TRV unit stores information about the hit object in the cache 250. For example, a bounding box represents a unit including a plurality of objects or primitives. The bounding box is expressed in other appropriate forms according to the relevant ASs.

In one example, the TRV unit searches for an AS by using a result of previous rendering or other appropriate previously determined information. In such an example, the TRV unit searches for an AS in the same path as that used in the previous rendering by using the result of the previous rendering, which is stored in the cache 250. In other words, when searching for an AS for an input ray, the TRV unit in this example preferentially searches for a bounding box hit by a previous ray having the same viewpoint and direction as the input ray. By reusing such information, the TRV unit minimizes redundant processing. For example, the TRV unit searches for an AS by referring to a search path for the previous ray.

In examples, cache 250 is a memory for temporarily storing data that is used when the TRV unit performs a TRV.

For example, the IST unit receives the object or leaf node hit by the ray from the TRV unit.

In such an example, the IST unit reads information about the primitives included in the hit object from the external memory 260. The read information about the primitives is stored in the cache 250. The cache 250 is a memory for temporarily storing data that is used when the IST unit performs an IST.

Thus, the IST unit performs an IST between a ray and a primitive to output a primitive hit by the ray and a hit point between the ray and the relevant primitive. The IST unit receives which object has been hit by the ray, from the TRV unit. The IST unit checks which of the primitives included in the hit object has been hit by the ray. The IST unit detects the primitive hit by the ray and outputs a hit point representing which point of the hit primitive was hit by the ray. The hit point is output in the form of coordinates to a shading unit.

In this example, the IST unit performs an IST by using a result of previous rendering. For example, the IST unit preferentially performs an IST on a primitive that is the same as that on which the previous rendering has been performed, by using the result of the previous rendering stored in the cache 250. Thus, when performing an IST on an input ray, the IST unit preferentially performs an IST on a primitive hit by a previous ray having the same viewpoint and direction as the input ray. By doing so, the IST unit reuses previous calculations and processing and reduces unnecessary and redundant resource utilization.

The shading unit determines a color value of a pixel based on information about the hit point received from the IST unit and the physical properties of a material of the hit point. For example, the shading unit determines a color value of the pixel in consideration of the basic color of the material of the hit point and the effects and attributes of a light source.

Also, the shading unit generates secondary rays based on information about the material of the hit point. Because reflection, refraction, and the like vary depending on the characteristics of the material of the hit point, the shading unit may generate secondary rays, such as a reflected ray and a refracted ray, according to the characteristics of the material of the hit point. For example, different materials have different reflective properties and/or different indexes of refraction. The shading unit also potentially generates a shadow ray based on the location of a light source, if the objects are arranged in a manner that a shadow ray is relevant.

In the example of FIG. 2, the ray tracing unit 280 receives data that is used for ray tracing from the external memory 260. In this example, the external memory 260 stores an AS or geometry data. The AC is generated by the AS generation apparatus 270 and stored in the external memory 260 thereafter. The geometry data represents information about primitives. In an example, each primitive has the shape of a polygon such as a triangle or a tetragon, and the geometry data represent information about the vertexes and locations of primitives included in the object. Such geometry data provides information about the shape of constituent parts of an object that govern how it is to appear when rendered.

The AS generation apparatus 270 generates an AS including location information of objects in a 3D space. Thus, in examples, the AS generation apparatus 270 divides the 3D space using the form of a hierarchical tree to represent the contents of the 3D space. The AS generation apparatus 270 generates various forms of ASs. In an example, the AS generation apparatus 270 generates an AS representing the relationship between objects in the 3D space by using a BVH or a KD-tree. In such an example, the AS generation apparatus 270 determines the maximum number of primitives of a leaf node and a depth of tree and generates an AS based on the determined maximum number of primitives and the determined depth of the tree.

In examples, the external memory 260 includes a storage medium capable of storing data. In an example, the external memory 260 is a dynamic random access memory (DRAM). A DRAM is a volatile memory device that constructs each bit by storing a bit using a single transistor and a single capacitor and loses its stored data when power is removed. However, other types of memory that store information are included in lieu of or in addition to a DRAM in other examples. In some other examples, such other types of memory potentially lose stored data when power is removed, but in other examples the memory is able to store data on a permanent basis even when power is removed.

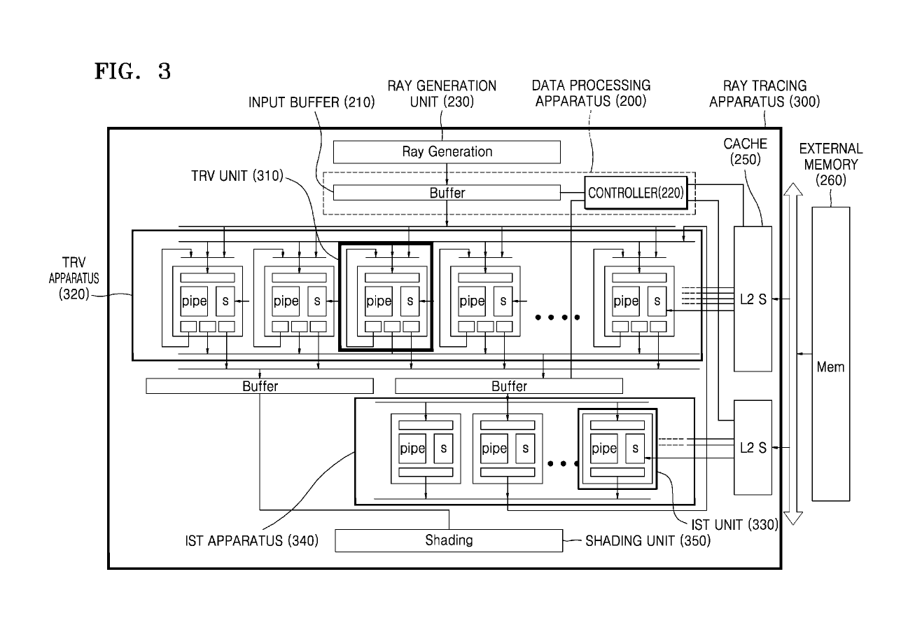

FIG. 3 is a block diagram illustrating a method in which the data processing apparatus 200 is implemented in a ray tracing apparatus 300, according to various examples.

Referring to FIG. 3, the ray tracing apparatus 300 includes the ray generation unit 230, the data processing apparatus 200, a TRV apparatus 3320, an IST apparatus 340, a shading unit 350, and the cache 250.

Although the ray generation unit 230, the data processing apparatus 200, the TRV apparatus 320, the IST apparatus 340, the shading unit 350, and the cache 250 are included in the ray tracing apparatus 300 itself in the example of FIG. 3, they are potentially implemented as independent hardware in other examples.

In the example of FIG. 3, the TRV apparatus 320 includes a plurality of TRV units 310.

Also in the example of FIG. 3, the IST apparatus 340 includes a plurality of IST units 330.

In one example, the cache 250 directly transmits or receives data to or from the TRV apparatus 320 or the IST apparatus 340. In such an example, the cache 250 transmits or receives data to or from the TRV apparatus 320 or the IST apparatus 340 while being located outside the TRV apparatus 320 or the IST apparatus 340, as illustrated in the example of FIG. 3. As another example, the cache 250 transmits data to or receives data from the TRV units 310 or the IST units 330 while being located within the TRV units 310 or the IST units 330.

The TRV apparatus 320 performs TRV operations in parallel by including the plurality of TRV units 310, and the IST apparatus 340 perform ISTs in parallel by including the plurality of IST units 330.

Execution of ray tracing, such as by the ray tracing apparatus 300, was described above with reference to FIG. 2.

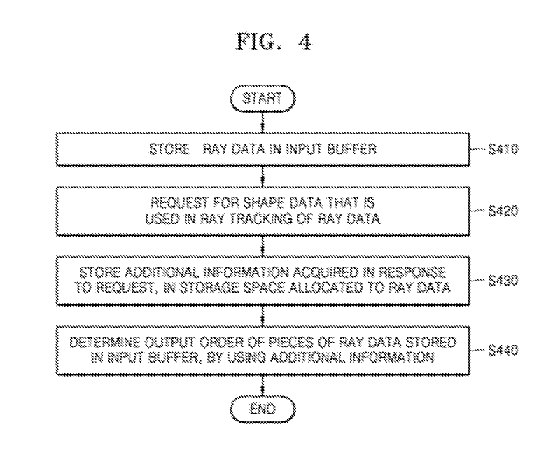

FIG. 4 is a flowchart of a method of determining an output order of pieces of ray data, according to various examples.

In operation S410, the input buffer 210 receives ray data from the ray generation unit 230 and stores the ray data.

In one example, the ray generation unit 230 generates a plurality of rays. For example, the ray generation unit 230 generates a primary ray and a secondary ray. Additional information about the operation of the ray generation unit 230 with respect to primary rays and secondary rays has already been presented above with reference to FIG. 2.

In operation S420, the controller 220 requests for shape data that is used in ray tracking of the ray data received and stored in operation S410.

The shape data is used to assist in ray tracing. Thus, in examples the shape data includes node data that is used in a TRV of an AS during ray tracing and object data that is used in an IST between a ray and a primitive during ray tracing.

In operation S430, the controller 220 stores additional information acquired in response to the request made in operation S420. For example, the additional information is also stored in a storage space allocated to the ray data received and stored in operation S410.

In one example, the input buffer 210 includes a storage space allocated to each piece of ray data that is stored in the input buffer 210. Additional information corresponding to each piece of ray data is stored in a storage space allocated to the ray data. The additional information is described above further with reference to FIG. 2.

For example, the controller 220 requests the cache 250 for shape data corresponding to ray data received by the input buffer 210 from the ray generation unit 230. In this example, the input buffer 210 also stores additional information acquired by request in a storage space allocated to the received ray data.

In operation S440, the controller 220 determines an output order of the ray data received in operation S410 in relation to the pieces of ray data stored in the input buffer 210, by using the additional information stored in operation S430.

In an example, the controller 220 also determines an output order of the pieces of ray data stored in the input buffer 210, based on pieces of additional information that respectively correspond to the stored pieces of ray data.

In one example, the controller 220 dynamically reorders the pieces of ray data stored in the input buffer 210. For example, the controller 220 determines the output order of the pieces of ray data stored in the input buffer 210, by using the pieces of additional information that respectively correspond to the pieces of ray data stored together with the pieces of ray data in the input buffer 210. This example is able to operate without using additional memory for storing additional information because the memory for storing additional information was previously allocated and hence no additional memory is necessary, minimizing resource usage.

In some examples, the additional information includes information such as at least one selected from a point in time when the controller 220 has requested the cache 250 for shape data, cache miss information indicating whether the requested shape data is contained in the cache 250, a point in time when the controller 220 has received the cache miss information, and a memory address representing the address of the external memory 260 where the shape data is stored. As noted, the additional information is able to facilitate reuse of rendering information.

A method of determining the output order of the pieces of ray data stored in the input buffer 210 by using additional information was described further above with reference to FIG. 2, and is not repeated here for brevity.

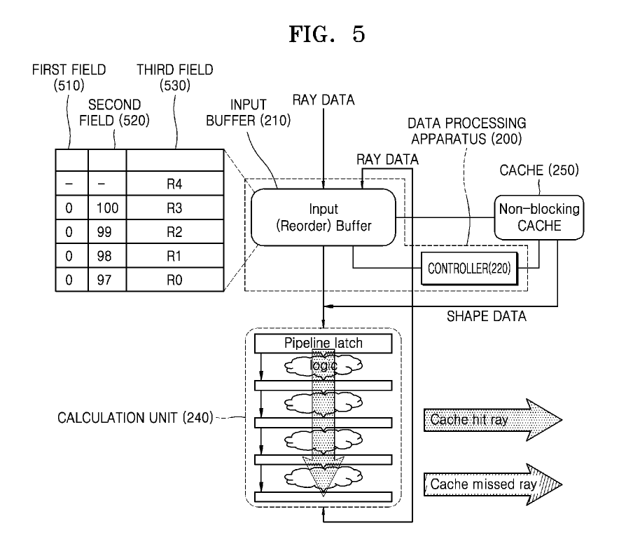

FIG. 5 is a block diagram for explaining a method of storing additional information corresponding to each ray data in a storage space allocated to the ray data, according to various examples.

Referring to FIG. 5, the input buffer 210 is divided into a plurality of fields.

In the example of FIG. 5, the input buffer 210 includes a first field 510, a second field 520, and a third field 530.

In such an example, a storage space is allocated to each piece of ray data that is stored in the input buffer 210. For example, each piece of ray data is stored in the third field 530, a latency counter corresponding to each piece of ray data is stored in the second field 520, and a valid bit corresponding to each piece ray data is stored in the first field 510. Accordingly, for each piece of ray data, a latency counter corresponding to each piece of ray data, and a valid bit corresponding to each piece of ray data are stored in the same row, such as in a storage table that organizes data in the input buffer 210.

A process of storing ray data and additional information corresponding to the ray data in the input buffer 210, according to an example, is now described further.

The input buffer 210 receives ray data R0. The controller 220 requests that the cache 250 provide shape data corresponding to the ray data R0. However, the requested shape data is potentially not contained in the cache 250. In this case, the input buffer 210 does not output the ray data R0 to the calculation unit 240 and stores the ray data R0 in the lowermost row of the third field 530. The input buffer 210 stores a latency counter of the ray data R0 in the lowermost row of the second field 520. The input buffer 210 stores a valid bit of the ray data R0 in the lowermost row of the first field 510.

In this way, data is stored in the input buffer 210. The controller 220 determines a processing order of pieces of ray data stored in the third field 530, based on corresponding values stored in the first and second fields 510 and 520.

Since different pieces of ray data are respectively stored in the rows of the input buffer 210, overflow does not occur when the input buffer 210 has an available storage space. Here, overflow refers to a state in which additional ray data cannot be stored in the input buffer 210. For example, overflow occurs in a situation where there is ray data which should be inserted into the input buffer 210, but the input buffer 210 is already filled to capacity.

Detailed operations of the input buffer 210, the controller 220, the calculation unit 240, and the cache 250 are described above, further, with reference to FIG. 2 and hence are omitted here for brevity.

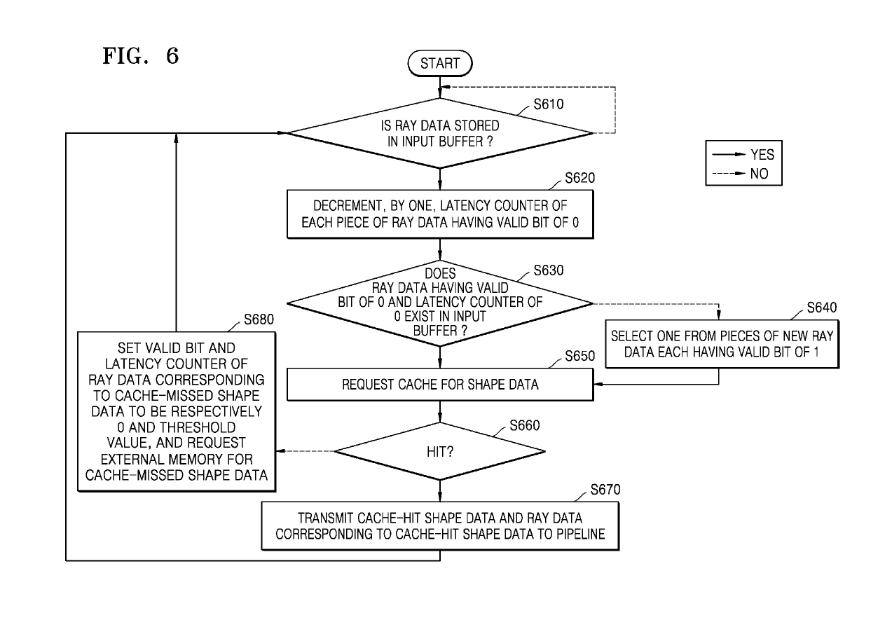

FIG. 6 is a flowchart of the method of FIG. 5.

In operation S610, the controller 220 determines whether ray data is stored in the input buffer 210.

If no ray data is stored in the input buffer 210, the method returns to operation S610, and thus the controller 220 determines whether ray data is stored in the input buffer 210.

In operation S620, the controller 220 decrements, by one, a latency counter of each piece of ray data having a valid bit of 0 from among one or more pieces of ray data stored in the input buffer 210. This operation takes into account the passage of time on the latency of pieces of ray data by updating the latency counters.

The latency counter refers to a value obtained by subtracting the current cycle from a sum of the estimated cycle and the cache miss cycle. Accordingly, the latency counter is decremented by one at the same time that the current cycle increases by one due to the relationship between these two values.

In operation S630, the controller 220 determines whether ray data having a valid bit of 0 and a latency counter of 0 is included in the one or more pieces of ray data stored in the input buffer 210.

The pieces of ray data having a valid bit of 0 and a latency counter of 0 are considered to be ray data for which a cache miss has occurred and for which a latency cycle has lapsed between the time when the cache miss has occurred and a current cycle.

If it is determined in operation S630 that the ray data that has a valid bit of 0 and a latency counter of 0 does not exist in the input buffer 210, the controller 220 selects one piece from pieces of new ray data each having a valid bit of 1, in operation S640.

When the ray data having a valid bit of 0 and a latency counter of 0 is not stored in the input buffer 210, the controller 220 sets new ray data to be output earlier than ray data previously stored in the input buffer 210.

Accordingly, in this situation, the controller 220 ascertains whether shape data corresponding to a new piece of ray data that has the highest output order is stored in the cache 250, in operation S650.

Thus, in operation S650, the controller 220 requests of the cache 250 for shape data corresponding to one piece of ray data from among pieces of ray data, each having a valid bit of 0 and a latency counter of 0 that have been determined to exist in the input buffer 210 in operation S630.

Alternatively, in operation S650, the controller 220 requests the cache 250 for shape data corresponding to one piece of ray data selected in operation S640.

In operation S660, the controller 220 determines whether the shape data requested in operation S650 is contained in the input buffer 210. Alternatively, the controller 220 determines whether a cache hit or a cache miss has occurred with respect to the ray data corresponding to the shape data requested in operation S650.

If it is determined in operation S660 that a cache hit has occurred, the controller 220 transmits cache-hit shape data and the ray data corresponding to the cache-hit shape data to the TRV unit or the IST unit, in operation S670.

In one example, the output ray data is deleted from the input buffer 210. In this example, the output ray data is also deleted from the cache 250.

If it is determined in operation S660 that a cache miss has occurred, in operation S680 the controller 220 sets the valid bit and the latency counter of the ray data corresponding to the cache-missed shape data to be, respectively, 0 and a threshold value. Also in operation S680, the controller 220 requests the external memory 260 for the cache-missed shape data.

In one example, the threshold value is the number of cycles taken to transmit data from the external memory 260 to the cache 250.

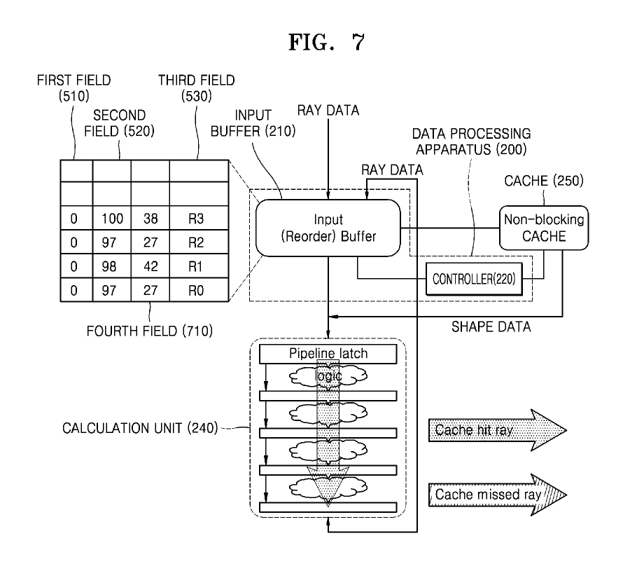

FIG. 7 is a block diagram illustrating a method of adding additional information to an input buffer, according to various examples.

Referring to FIG. 7, a data processing method and a data processing apparatus according to various examples include some of the matters illustrated in FIGS. 5 and 6. Although omitted for brevity, descriptions of the matters illustrated in FIGS. 5 and 6 are still applicable, where appropriate, to the data processing method and the data processing apparatus of FIG. 7.

Referring to FIG. 7, the input buffer 210 is divided into a plurality of fields.

In the example of FIG. 7, the input buffer 210 includes the first field 510, the second field 520, the third field 530, and a fourth field 710.

In another example, the input buffer 210 further includes other fields in addition to the first field 510, the second field 520, the third field 530, and the fourth field 710.

However, in the example of FIG. 7, the input buffer 210 includes the fourth field 710.

As shown in FIG. 7, the fourth field 710 stores the address in the external memory 260 in which shape data corresponding to a piece of ray data is stored. The address of the external memory 260 in which shape data corresponding to a piece of ray data is stored is hereinafter referred to as a ray address. Alternatively, the ray address refers to a memory address that is requested by ray data when a cache miss has occurred.

In the example of FIG. 7, an R0 ray address, which is a memory address where the ray data R0 is stored, and an R2 ray address, which is a memory address where the ray data R2 is stored, are the same, that is, an address value of 27. Accordingly, when shape data corresponding to the R0 ray data is fetched and stored in the cache 250, shape data corresponding to the R2 ray data is also fetched and stored in the cache 250, because the memory address of 27 of the external memory 260 has been accessed while the cache 250 is receiving the shape data corresponding to the R0 ray data from the external memory 260.

Therefore, although the order in which ray data is stored in the input buffer 210 is an order of R0 ray data, R1 ray data, R3 ray data, and R4 ray data, the controller 220 sets the latency counter value of the R0 ray data and the latency counter value of the R2 ray data to be identical to each other. For example, the latency counter value of the R2 ray data is updated to the latency counter value of the R0 ray data.

Since the memory address of 27 of the external memory 260 has already been requested for shape data by the R0 ray data before the external memory 260 is requested for shape data by the R2 ray data, the controller 220 omits a request of the R2 ray data for shape data by re-adjusting the value of the latency counter. By operating in this manner, it is possible to minimize redundant requests for data.

In an example, a similarity between the output orders of the pieces of ray data corresponding to an identical memory address is increased by assigning an identical output order to each of the pieces of ray data that correspond to the identical memory address. In addition, due to the adjustment of the output order of the pieces of ray data, the outputting of the pieces of ray data is reordered in an advantageous manner that maximizes efficiency.

When a cache hit has occurred for one of the pieces of ray data corresponding to an identical memory address, a cache hit also potentially occurs for another piece of ray data. Thus, in such a situation, the controller 220 assigns an identical output order to the pieces of ray data that correspond to an identical memory address to thereby output pieces of ray data for which a period of time corresponding to an estimated time difference has not lapsed after a cache miss has occurred.

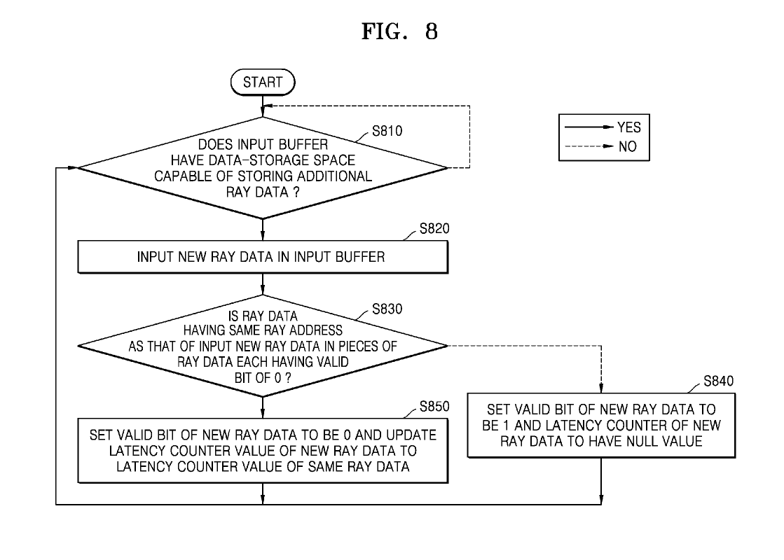

FIG. 8 is a flowchart of the method of FIG. 7.

In operation S810, the controller 220 determines whether the input buffer 210 has a data storage space capable of storing additional ray data.

In operation S820, the input buffer 210 receives new ray data from the ray generation unit 230.

In operation S830, the controller 220 determines whether ray data having the same ray address as that of the new ray data received in operation S820 is included in pieces of ray data each having a valid bit of 0 stored in the input buffer 210.

The ray address refers to an address of the external memory 260 in which shape data corresponding to a piece of ray data is stored. Alternatively, the ray address refers to a memory address requested by ray data when a cache miss has occurred.

In operation S840, the controller 220 sets a valid bit of the new ray data to be 1 and a latency counter of the new ray data to have a null value. In examples, the null value is a value that is neither 0 nor 1, or has a predetermined value.

In operation S850, the controller 220 sets a valid bit of the new ray data to be 0. When the ray data having the same ray address as that of the new ray data received in operation S820 is referred to as same ray data, the controller 220 updates the value of the latency counter of the new ray data to a latency counter value of the same ray data.

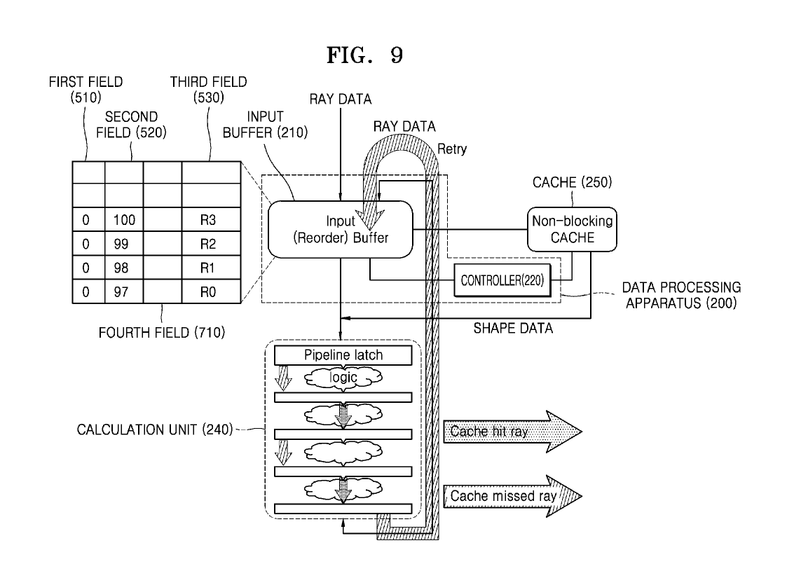

FIG. 9 is a block diagram illustrating a method of processing cache-missed ray data, according to various examples.

Referring to FIG. 9, a data processing method and a data processing apparatus according to various examples include some of the matters illustrated in FIGS. 5-8. Although omitted hereinafter for brevity, descriptions of the matters illustrated in FIGS. 5-8 are still applicable, where appropriate, to the data processing method and the data processing apparatus of FIG. 9.

In the example of FIG. 9, even when a cache miss has occurred, the controller 220 outputs ray data to the calculation unit 240 in a certain case. The ray data is deleted from the input buffer 210 after being output to the calculation unit 240. When the ray data is output to the calculation unit 240, shape data corresponding to the ray data is potentially not output to the calculation unit 240. Accordingly, the calculation unit 240 does not perform a TRV or an IST because there is no shape data to be processed. However, since the calculation unit 240 has received the ray data, the calculation unit 240 outputs the ray data according to an operation cycle of the calculation unit 240 without performing a substantial calculation. The ray data output by the calculation unit 240 is transmitted to the input buffer 210.

A process in which the controller 220 outputs only the ray data without shape data to the calculation unit 240 and deletes the ray data from the input buffer 210 as described above is referred to as an invalidation process. A process in which the calculation unit 240 transmits, back to the input buffer 210, ray data on which an invalidation process has been performed is referred to as a retrial process.

The above-described invalidation process is performed in a certain case.

For example, when a storage space in the input buffer 210 that is capable of storing additional ray data is less than or equal to a threshold value, the above-described invalidation process is performed. Such a process acts to free additional storage space.

As another example, when overflow occurs in the input buffer 210, the above-described invalidation process is performed. The overflow refers to a state in which additional ray data cannot be stored in the input buffer 210.

Thus, when overflow has occurred in the input buffer 210, the controller 220 output even cache-missed ray data to the calculation unit 240 to avoid a pipeline stall. The ray data received by the calculation unit 240 during the invalidation process is bypassed in a pipeline and transmitted to the input buffer 210 via a feedback path. For example, the controller 220 re-requests the cache 250 for shape data corresponding to the ray data on which a validation process has been performed.

As described above, according to the one or more of the above examples, a method of reducing latency that occurs during an access to a memory or a method for avoiding a pipeline stall are provided during rendering.

The apparatuses and units described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a hardware component may include multiple processors or a processor and a controller. In addition, different processing configurations are possible, such as parallel processors.

The methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The media may also include, alone or in combination with the software program instructions, data files, data structures, and the like. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

As a non-exhaustive illustration only, a terminal/device/unit described herein may refer to mobile devices such as, for example, a cellular phone, a smart phone, a wearable smart device (such as, for example, a ring, a watch, a pair of glasses, a bracelet, an ankle bracket, a belt, a necklace, an earring, a headband, a helmet, a device embedded in the cloths or the like), a personal computer (PC), a tablet personal computer (tablet), a phablet, a personal digital assistant (PDA), a digital camera, a portable game console, an MP3 player, a portable/personal multimedia player (PMP), a handheld e-book, an ultra mobile personal computer (UMPC), a portable lab-top PC, a global positioning system (GPS) navigation, and devices such as a high definition television (HDTV), an optical disc player, a DVD player, a Blu-ray player, a setup box, or any other device capable of wireless communication or network communication consistent with that disclosed herein. In a non-exhaustive example, the wearable device may be self-mountable on the body of the user, such as, for example, the glasses or the bracelet. In another non-exhaustive example, the wearable device may be mounted on the body of the user through an attaching device, such as, for example, attaching a smart phone or a tablet to the arm of a user using an armband, or hanging the wearable device around the neck of a user using a lanyard.

A computing system or a computer may include a microprocessor that is electrically connected to a bus, a user interface, and a memory controller, and may further include a flash memory device. The flash memory device may store N-bit data via the memory controller. The N-bit data may be data that has been processed and/or is to be processed by the microprocessor, and N may be an integer equal to or greater than 1. If the computing system or computer is a mobile device, a battery may be provided to supply power to operate the computing system or computer. It will be apparent to one of ordinary skill in the art that the computing system or computer may further include an application chipset, a camera image processor, a mobile Dynamic Random Access Memory (DRAM), and any other device known to one of ordinary skill in the art to be included in a computing system or computer. The memory controller and the flash memory device may constitute a solid-state drive or disk (SSD) that uses a non-volatile memory to store data.

A terminal, which may be referred to as a computer terminal, may be an electronic or electromechanical hardware device that is used for entering data into and displaying data received from a host computer or a host computing system. A terminal may be limited to inputting and displaying data, or may also have the capability of processing data as well. A terminal with a significant local programmable data processing capability may be referred to as a smart terminal or fat client. A terminal that depends on the host computer or host computing system for its processing power may be referred to as a thin client. A personal computer can run software that emulates the function of a terminal, sometimes allowing concurrent use of local programs and access to a distant terminal host system.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A data processing method comprising:
storing ray data in an input buffer;
requesting shape data that is used in ray tracing of the ray data;
acquiring additional information corresponding to the shape data in response to the request and storing the additional information in a storage space allocated to the ray data; and
determining an output order of pieces of ray data stored in the input buffer, based on the additional information.

2. The data processing method of claim 1, wherein
the requesting of the shape data comprises requesting of a cache to transmit the shape data, and
the determining of the output order comprises determining that the ray data is to be output first, when the shape data corresponding to the ray data is contained in the cache.

3. The data processing method of claim 2, further comprising:
outputting the ray data and deleting the ray data from the input buffer, in response to the shape data being contained in the cache.

4. The data processing method of claim 1, wherein
the requesting of the shape data comprises requesting of a cache to transmit the shape data, and
the additional information comprises at least one of a point in time at which the shape data was requested, cache miss information indicating whether the shape data is contained in the cache, a point in time at which the cache miss information was received, and a memory address where the shape data is stored.

5. The data processing method of claim 4, wherein the determining of the output order comprises setting pieces of ray data that have an identical memory address to be output in the same order as each other or in an adjacent order to each other.

6. The data processing method of claim 4, wherein the determining of the output order comprises, in response to the shape data not being contained in the cache, setting ray data that has a larger time difference between the point in time when the cache miss information has been received and a current point in time, to be output earlier than ray data that has a smaller time difference therebetween.

7. The data processing method of claim 4, wherein the determining of the output order comprises, in response to the shape data not being contained in the cache, determining the output order based on a result of a comparison between a latency time difference between the point in time at which the cache miss information has been received and a current point in time and an estimated time difference that is a time interval taken to transmit data from a memory to the cache.

8. The data processing method of claim 1, wherein the shape data comprises at least one of node data that is used in a traversal (TRV) of an acceleration structure (AS) during ray tracing and primitive data that is used in an intersection test (IST) during ray tracing.

9. The data processing method of claim 1, further comprising outputting the ray data and the shape data to a traversal (TRV) unit or an intersection test (IST) unit in the determined output order.

10. A data processing apparatus comprising:
a controller configured to request shape data that is used in ray tracing of ray data and determines an output order of pieces of ray data stored in an input buffer, based on additional information about the shape data; and
an input buffer configured to store additional information acquired in response to the request of the controller for the shape data in a storage space allocated to each of the pieces of ray data.

11. The data processing apparatus of claim 10, wherein the controller requests of a cache to transmit the shape data and, in response to the shape data being contained in the cache, determines that the ray data is to be output first.

12. The data processing apparatus of claim 11, wherein the controller outputs the ray data and deletes the ray data from the input buffer, in response to the shape data being contained in the cache.

13. The data processing apparatus of claim 10, wherein
the controller requests of a cache to transmit the shape data, and
the additional information comprises at least one of a point in time when the shape data has been requested, cache miss information indicating whether the shape data is contained in the cache, a point in time at which the cache miss information has been received, and a memory address where the shape data is stored.

14. The data processing apparatus of claim 13, wherein the controller sets pieces of ray data that have an identical memory address to be output in the same order as each other or in an adjacent order to each other.

15. The data processing apparatus of claim 13, wherein the controller sets ray data that has a larger time difference between the point in time when the cache miss information has been received and a current point in time, to be output earlier than ray data which has a smaller time difference therebetween, in response to the shape data not being contained in the cache.

16. The data processing apparatus of claim 13, wherein, in response to the shape data not being contained in the cache, the controller determines the output order based on a result of a comparison between a latency time difference between the point in time at which the cache miss information has been received and a current point in time and an estimated time difference that is a time interval taken to transmit data from a memory to the cache.

17. The data processing apparatus of claim 10, wherein the shape data comprises at least one of node data that is used in a traversal (TRV) of an acceleration structure (AS) during ray tracing and primitive data that is used in an intersection test (IST) during ray tracing.

18. The data processing apparatus of claim 10, wherein the controller outputs the ray data and the shape data to a traversal (TRV) unit or an intersection test (IST) unit in the determined output order.

19. A non-transitory computer-readable recording medium storing a program for data processing, the program comprising instructions for causing a computer to perform the data processing method of claim 1.

20. A data processing method comprising:
requesting shape data that is used in ray tracing of ray data stored in an input buffer;
acquiring additional information corresponding to the shape data in response to the request and storing the additional information in a storage space allocated to the ray data; and
determining an output order of pieces of ray data stored in the input buffer, based on the additional information.
